(19) United States
(12) Patent Application Publication
(10) Pub. No.: US 2009/0015500 A1
(43) Pub. Date: Jan. 15, 2009

(54) Antenna Device

(76) Inventors: Akihiro Hoshiai, Osaka (JP); Yuki Satoh, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/547,134

(22) PCT Filed: Apr. 6, 2006
(86) PCT No.: PCT/JP2006/307314

§ 371 Date: Oct. 4, 2006

(30) Foreign Application Priority Data
Apr. 7, 2005 (JP) 2005-110614

(51) Int. Cl. H01Q 11/10

(52) U.S. Cl. 343/792.5

(57) ABSTRACT

An antenna device includes a power supply, a first antenna element, a second antenna element, and a film. The first antenna element includes a first feed line connected with the power supply, and first radiators connected with the first feed line and arranged along the drawing direction of the first feed line. The second antenna element includes a second feed line connected with the power supply, and second radiators connected with the second feed line and arranged along the drawing direction of the second feed line. The second antenna element is linearly symmetric with the first antenna element. The film holds at least the first and second antenna elements.

### TECHNICAL FIELD

The present invention relates to an antenna device for in-car digital televisions.

### BACKGROUND ART

As television digitalization progresses, antenna devices used for in-car televisions are being designed to cover a wider range of frequencies so as to be compatible with digital televisions. Such an antenna device is disclosed, for example, in Japanese Patent Unexamined Publication No. 2002-353714 where an unbalanced antenna device is used which covers a wider range of frequencies.

However, in the unbalanced antenna device, a part of the car body that forms the ground functions as part of a radiator, so that a change in the installation position of the antenna device affects antenna performance. Therefore, installing the unbalanced antenna device in a car involves very delicate operations.

### SUMMARY OF THE INVENTION

The present invention is directed to provide an antenna device with improved ease of installation. The antenna device of the present invention includes a power supply, a first antenna element, a second antenna element, and a film. The first antenna element includes a first feed line connected with the power supply and first radiators connected with the first feed line and arranged along the drawing direction of the first feed line. The second antenna element includes a second feed line connected with the power supply and second radiators connected with the second feed line and arranged along the drawing direction of the second feed line. The first antenna element and the second antenna element are linearly symmetric with each other. The film holds at least the first and second antenna elements. This structure can improve the ease of installation of an antenna device for in-car digital televisions.

### BRIEF DESCRIPTION OF THE DRAWINGS

FIG. 1 is a schematic plan view of an antenna device of an embodiment of the present invention.

FIG. 2 is a cross sectional view of another antenna device of the embodiment of the present invention.

FIG. 3 is a schematic plan view of the antenna device shown in FIG. 2.

### REFERENCE MARKS IN THE DRAWINGS

1 power supply
2, 12 first antenna element
3, 13 second antenna element
4, 4A, 4B, 4C film
5 first feed line
6, 16 second feed line
7, 17 first radiators
8, 18 second radiators
41 first surface
42 second surface

### DETAILED DESCRIPTION OF THE PREFERRED EMBODIMENT

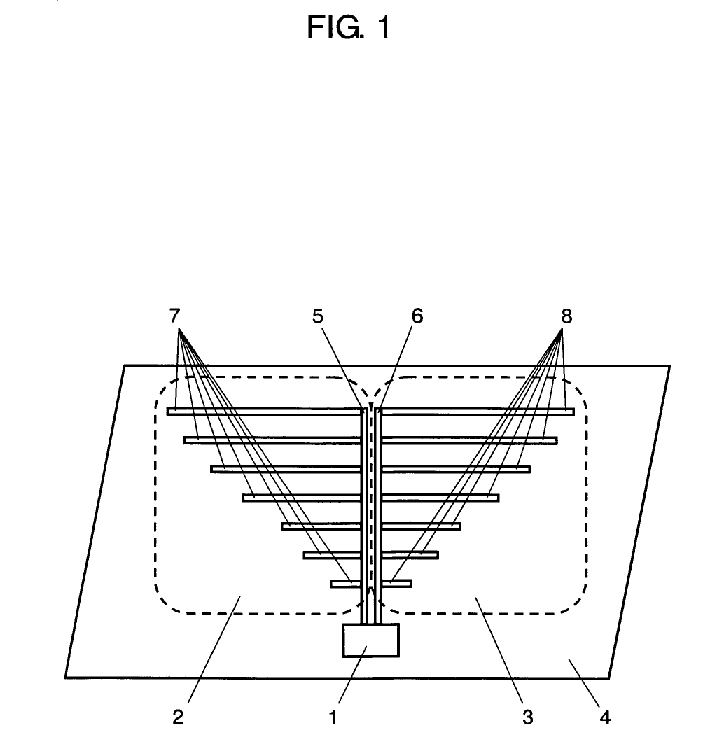

FIG. 1 is a schematic plan view of an antenna device of an embodiment of the present invention. This antenna device is designed for in-car digital televisions and pasted on a car windshield when used. Digital televisions transmit and receive signals in a wide frequency range, namely, 470 MHz to 770 MHz. Therefore, antenna devices used for these televisions are required to have high sensitivity in such a very wide frequency range.

This antenna device includes power supply 1, first antenna element (hereinafter, element) 2, second antenna element (hereinafter, element) 3, and films 4. Elements 2 and 3 are connected with power supply 1 and integrated with each other via films 4. In other words, films 4 hold at least elements 2 and 3.

Element 2 includes first feed line (hereinafter, line) 5 extending straight from power supply 1, and first radiators (hereinafter, radiators) 7 arranged in the direction orthogonal to line 5. Similarly, element 3 includes second feed line (hereinafter, line) 6 extending straight from power supply 1, and second radiators (hereinafter, radiators) 8 arranged in the direction orthogonal to line 6. Thus, a balanced antenna is structured.

Power supply 1 and elements 2, 3 can be, for example, copper wires or conductive patterns formed by printing silver paste on films 4. Films 4 are made of polyester or the like and sandwich power supply 1 and elements 2, 3 therebetween. Films 4 may have a clear coating on their surfaces. Films 4 not only hold power supply 1 and elements 2, 3 but also function as protecting materials for them. For this reason, films 4 are preferably applied on both sides of power supply 1 and elements 2, 3; however, when these components are protected by a coating or the like, only one film 4 may be provided. In a case where power supply 1 is a metal terminal or the like, it may be disposed either outside or on the periphery of films 4 because it does not need to be held by films 4.

Thus, radiators 7 and 8 are symmetrically arranged to make elements 2 and 3 linearly symmetric with each other, thereby forming a balanced antenna device. This arrangement overcomes the following conventional problem in antenna installation: the car body functions as a radiator. In other words, this arrangement enables the antenna device to be independent from the car body, thereby improving the ease of installation of the antenna device.

In elements 2 and 3, the lengths of radiators 7 change gradually between the power-supply 1 side and the tip side of line 5, and the lengths of radiators 8 also change gradually between the power-supply 1 side and the tip side of line 6. In other words, radiators 7 and 8 become either increasingly longer or decreasingly shorter in length as they are further from the power-supply 1 side of lines 5 and 6, respectively. In this structure, radiators 7 each have a different resonant frequency, and radiators 8 also each have a different resonant frequency. Radiators 7 and 8 thus having different resonant frequencies are connected with lines 5 and 6, respectively, so that elements 2 and 3 have antenna performance in a wide range, respectively. Thus, the antenna device can cover the frequency range of digital televisions.

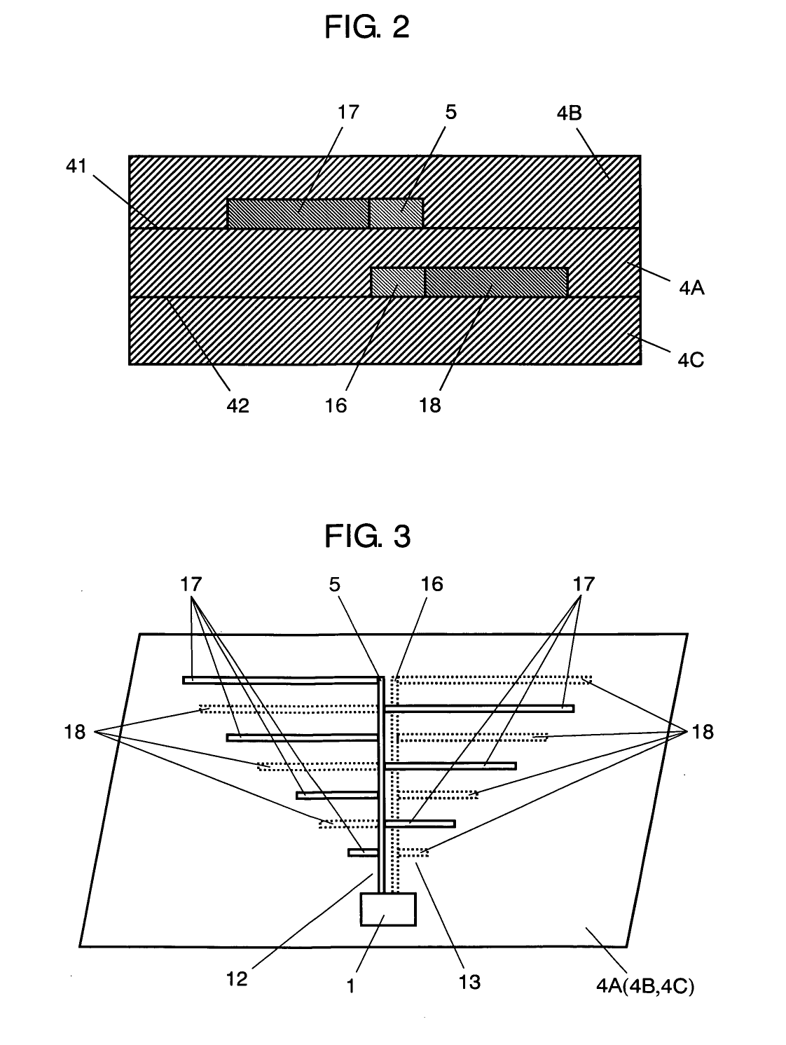

The following is a description of another antenna device of the present embodiment. FIG. 2 is a cross sectional view of another antenna device of the embodiment of the present invention, and FIG. 3 is a schematic plan view of the antenna device.

In this structure, first antenna element (hereinafter, element) 12 is formed on the first-surface 41 side of film 4A, and second antenna element (hereinafter, element) 13 is formed on the second-surface 42 side which faces the first-surface 41 side. Elements 12 and 13 are covered with films 4B and 4C, respectively, from both sides of film 4A. Element 12 is provided with line 5 extending straight from power supply 1, and first radiators (hereinafter, radiators) 17 arranged in the direction orthogonal to line 5. Similarly, element 13 is provided with line 6 extending straight from power supply 1, and second radiators (hereinafter, radiators) 18 arranged in the direction orthogonal to line 6. In the same manner as the structure of FIG. 1, radiators 17 and 18 are symmetrically arranged to make elements 12 and 13 linearly symmetric with each other, thereby forming a balanced antenna device. Alternatively, the antenna device can be produced by providing element 12 on film 4B and element 13 on film 4A and stacking films 4B, 4A, and 4C in this order so as to prevent the surface with element 12 thereon from being overlapped with the surface with element 13 thereon.

As shown in FIG. 3, each of radiators 17 is preferably interposed between two of radiators 18 so as to increase the directivity of the antenna device.

This antenna device is pasted on a car windshield when used. In this condition, the antenna device receives not only signals coming directly from outside the car, but also signals reflected inside the car after coming from outside the car. These two kinds of signals have a time lag between them, resulting in an increase in the number of error components in a tuner used in a later stage. To avoid this problem, the antenna device is provided with directivity and designed to receive exclusively one kind of signals such as those coming from outside the car. This improves the performance of in-car antenna device.

### INDUSTRIAL APPLICABILITY

The antenna device of the present invention is useful as a signal-receiving in-car device because it can be installed easily regardless of the body shape of a car on which to install the antenna device and can receive digital television signals.

1. An antenna device comprising:
a power supply;
a first antenna element including a first feed line connected with the power supply, and first radiators connected with the first feed line and arranged along a drawing direction of the first feed line;
a second antenna element including a second feed line connected with the power supply, and second radiators connected with the second feed line and arranged along a drawing direction of the second feed line, the second antenna element being linearly symmetric with the first antenna element; and
a film for holding at least the first antenna element and the second antenna element.

2. The antenna device according to claim 1 wherein
the first radiators and the second radiators become one of increasingly longer and decreasingly shorter in length as the first radiators and the second radiators are further from the power supply along the first feed line and the second feed line, respectively.

3. The antenna device according to claim 1 wherein
the first antenna element is disposed on a first surface side of the film;
the second antenna element is disposed on a second surface side of the film, the second surface being opposite to the first surface; and
each of the second radiators is disposed between two of the first radiators.
